(19) United States
(12) Patent Application Publication
(10) Pub. No.: US 2015/0105967 A1
(43) Pub. Date: Apr. 16, 2015

(54) PLUG-IN COMMUNICATION DEVICE FOR A MOTOR VEHICLE

(71) Applicant: FORD GLOBAL TECHNOLOGIES, LLC, Dearborn, MI (US)

(72) Inventors: David SKIPP, Brentwood (GB); Jonathan SCOTT, Chelmsford (GB); Douglas NICOLL, Broomfield (GB)

(21) Appl. No.: 14/514,960

(22) Filed: Oct. 15, 2014

(30) Foreign Application Priority Data
Oct. 16, 2013 (GB) 1318281.1

(51) Int. Cl. G07C 5/00; G07C 5/08

(52) U.S. Cl. CPC G07C 5/008; G07C 5/0808
USPC 701/31.4

(57) ABSTRACT

An apparatus for transferring data from a motor vehicle to a remote data processing system includes a first plug-in device for insertable into an on-board diagnostic (OBD) port of the vehicle and a second plug-in device insertable into a power socket of the vehicle. The first plug-in device receives power from and collects diagnostic data from the OBD port and transmits the data via a short-range communications link. The second plug-in device receives power from the power socket, receives the diagnostic data transmitted by the first plug-in device, and re-transmits the diagnostic data along with a geographic location of the vehicle to a remote data processing system. The apparatus provides a simple and cost-effective device that can be fitted to the current vehicle stock in order to enable the rapid introduction of intelligent vehicle monitoring systems.

### CROSS-REFERENCE TO RELATED APPLICATIONS

This application claims foreign priority benefits under 35 U.S.C. §119(a)-(d) to GB 1318281.1 filed Oct. 16, 2013, which is hereby incorporated by reference in its entirety.

### TECHNICAL FIELD

This invention relates to an apparatus for communicating information relating to the motor vehicle to a remote location, and more specifically to such an apparatus that includes a removable plug-in device that is inserted into electrical connection with an existing electric power outlet of the vehicle.

### BACKGROUND

Increasingly there is a demand for a motor vehicle to be able to interact with other remote devices such as remote data processing systems for intelligent vehicle monitoring purposes such as, for example, intelligent transport systems, intelligent parking systems and vehicle usage systems.

Such systems rely on the transfer of data regarding various attributes of the motor vehicle to a remote data processing system in order to provide the required functionality. Future vehicle will likely be fitted with integrated systems to provide the required data.

For example, in the case of an intelligent traffic system it is necessary to know the location of the majority of motor vehicles within a defined area in order to efficiently control the flow of traffic in that area. It is a problem with the rapid implementation of such intelligent traffic systems that many existing vehicles (current vehicle stock) do not have the functionality required in order to implement such a system with any degree of efficiency. That is to say, if only a small percentage of the vehicles travelling in a defined area are visible to the intelligent traffic control system it cannot efficiently control the flow of traffic.

In the case of an intelligent parking system it is necessary to know whether a predefined parking space is currently occupied in order to provide guidance to a suitably equipped vehicle of available parking spaces in close proximity to the motor vehicle. Once again, if only a small percentage of the vehicles parked in predefined parking spaces are visible to the intelligent parking system then it cannot efficiently control the flow of traffic to vacant parking spaces.

Vehicle usage systems can be used for various purposes such as for example and without limitation, electronic toll systems such as road tolls and parking tolls, accident investigation, speed monitoring, vehicle fault warning systems and emission monitoring for carbon tax levying purposes.

Therefore there is a requirement to provide a simple and cost effective device that can be fitted to the current vehicle stock in order to enable the rapid introduction of intelligent vehicle monitoring systems.

### SUMMARY

It is an object of this invention to provide an apparatus that can in a simple and cost effective manner be fitted to the current motor vehicle stock so as to enable the rapid introduction of intelligent vehicle monitoring.

According to a first aspect of the invention there is provided an apparatus for transferring information from a motor vehicle to at least one remote data processing system, wherein the apparatus comprises at least one plug-in device having an integral electrical connector for connecting the device to an existing electric power outlet on the motor vehicle, a location module to provide data from which the current position of the motor vehicle to which the device is fitted can be determined, and a communication module to provide a communication link between the plug-in device and the at least one remote data processing system.

There may be a single plug-in device and the single plug-in device may further comprise a memory module storing a unique identity mark for the plug-in device.

There may be a single plug-in device and the single plug-in device may further comprise a power module having an electrical energy storage device for providing electrical power to at least one other module of the plug-in device if a supply of electrical power from the motor vehicle is not available.

There may be a single plug-in device and the single plug-in device may further comprise an accelerometer module to provide information regarding the dynamic behavior of the motor vehicle to which the plug-in module is fitted.

There may be a single plug-in device and the communication module may be a long range communication module to provide the communication link between the plug-in device and the at least one remote data processing system.

Alternatively there may be a single plug-in device and the communication module may be a short range communication module to provide a communication link between the plug-in device and a mobile communication device and the communication link between the plug-in device and the at least one remote data processing system may be provided via the mobile communication device.

There may be a single plug-in device and the single plug-in device may further comprise an on-board diagnostic module to collect data regarding the operation of the motor vehicle to which the plug-in module is fitted. In which case the existing electric power outlet may be an on-board diagnostics port on the motor vehicle and the electrical connector may be a plug for co-operation with the on-board diagnostics port.

Alternatively, the existing electric power outlet may be a power socket on the motor vehicle and the electrical connector may be a plug for co-operation with the power socket.

The power socket may be a standard 12 volt power socket.

The apparatus may comprise first and second plug-in devices, wherein the first plug-in device has an electrical plug for connecting the first plug-in device to an existing electric power outlet on the motor vehicle, a first communication module to provide the communication link between the first plug-in device and the remote data processing system and a second communication module to provide a communication link between the first plug-in device and the second plug-in device and the second plug-in device may have an electrical plug for connecting the second plug-in device to an existing electric power outlet on the motor vehicle in the form of an on-board diagnostics port, an on-board diagnostics module and a communication module for communicating with the second communication module of the first plug-in module.

The first communication module may be a long range communication module to provide the communication link between the first plug-in device and the remote data processing system.

The plug-in device may have a short range communication module to provide a communication link between the plug-in device and a mobile communication device and the communication link between the plug-in device and the remote data processing system is provided via the mobile communication device.

At least one of the first and second plug-in devices may have a power module having an electrical storage device for providing electrical power to at least one other module of the plug-in device if a supply of electrical power from the motor vehicle is not available.

One of the first and second plug-in devices may further comprise a memory module storing a unique identity mark for the respective plug-in device.

One of the first and second plug-in devices may further comprise an accelerometer module to provide information regarding the dynamic behavior of the motor vehicle to which the plug-in module is fitted.

The first plug-in device may comprise the electrical plug for connecting the first plug-in device to a power socket, the first communication module to provide the communication link between the first plug-in device and the remote data processing system, the second communication module to provide a communication link between the first plug-in device and the second plug-in device and a memory module storing a unique identity mark for the first plug-in device and a battery for providing electrical power to at least one other module of the first plug-in device if a supply of electrical power from the motor vehicle is not available and the second plug-in device may comprise the electrical plug for connecting the second plug-in device to the on-board diagnostics port, the communication module for communicating with the second communication module of the first plug-in module, an on-board diagnostic module to collect data regarding the operation of the motor vehicle to which the plug-in module is fitted and a battery for providing electrical power to at least one other module of the second plug-in device if a supply of electrical power from the motor vehicle is not available.

According to a second aspect of the invention there is provided a motor vehicle having an electric power circuit and at least one plug-in device forming part of an apparatus constructed in accordance with said first aspect of the invention connected to the electric power circuit of the motor vehicle for communicating information regarding the motor vehicle to at least one remote data processing system.

The invention will now be described by way of example with reference to the accompanying drawing of which:

### BRIEF DESCRIPTION OF THE DRAWINGS

FIG. 1A is a schematic diagram of a motor vehicle having an apparatus for transferring information;

FIG. 1B is a schematic diagram of the plug-in device of FIG. 1A

FIG. 2A is a schematic diagram of a motor vehicle having a second embodiment of an apparatus for transferring information;

FIG. 2B is a schematic diagram of the plug-in device of FIG. 3A;

FIG. 3A is a schematic diagram of a motor vehicle having a third embodiment of an apparatus for transferring information;

FIG. 3B is a schematic diagram of the plug-in device of FIG. 3A;

FIG. 4A is a schematic diagram of a motor vehicle having a fourth embodiment of an apparatus for transferring information;

FIG. 4B is a schematic diagram of the plug-in device of FIG. 4A;

FIG. 5A is a schematic diagram of a motor vehicle having a fifth embodiment of an apparatus for transferring information;

FIG. 5B is a schematic diagram of the plug-in device of FIG. 5A;

FIG. 6A is a schematic diagram of a motor vehicle having a sixth embodiment of an apparatus for transferring information; and

FIG. 6B is a schematic diagram of the plug-in device of FIG. 6A.

### DETAILED DESCRIPTION

As required, detailed embodiments of the present invention are disclosed herein; however, it is to be understood that the disclosed embodiments are merely exemplary of the invention that may be embodied in various and alternative forms. The Figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

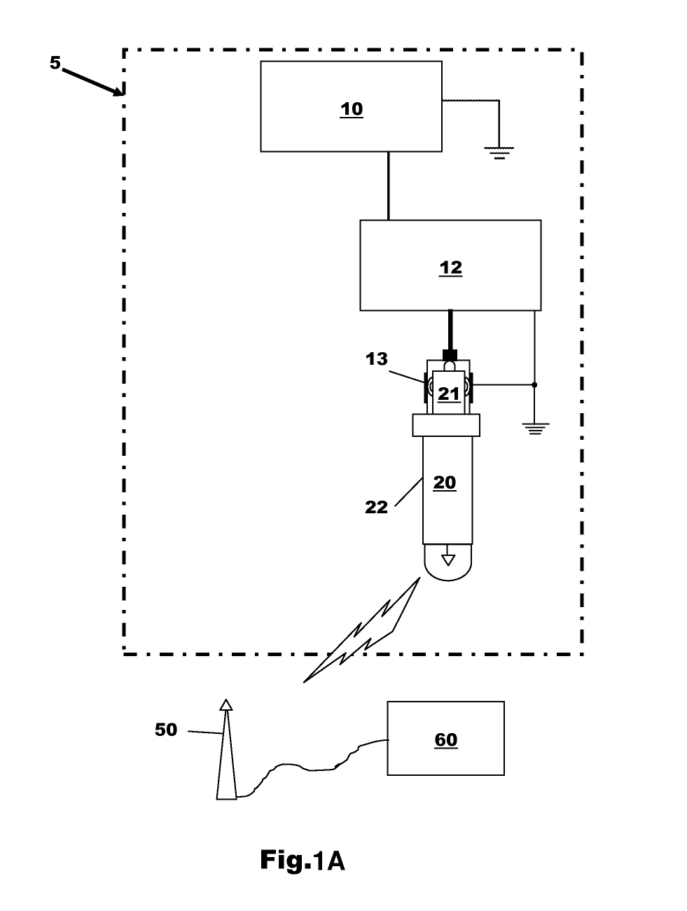

With particular reference to FIGS. 1A and 1B there is shown a motor vehicle 5 having a number of electrical systems 10 supplied with power from a main electric power system 12 of the motor vehicle 5. It will be appreciated that the motor vehicle 5 also includes various other systems and components such as, for example and without limitation, a propulsion system, a transmission system, a number of road wheels, a suspension system, a body structure and accommodation for one or more occupants. None of these additional systems and components is shown on FIG. 1A as they are not directly relevant to the current invention.

As is well known in the art, the electric power system 12 includes a distribution system (wiring loom, wiring harness, or cable harness), a source of electric power such as a generator and at least one battery or electrical power storage device for use when the generator is not operating. The electric power system 12 also includes a number of 12 volt power sockets 13 which may be in the form of a cigar or cigarette lighter socket 13. As is well known in the art such electrical power sockets are universally applied to motor vehicles and are of a standard design and configuration.

A first embodiment of an apparatus for transferring information from the motor vehicle 5 to a remote data processing system 60 is provided in the form of a single plug-in device 20. In the case of this first embodiment the plug-in device 20 communicates directly with the remote data processing system 60 via a wireless terrestrial link including one or more ground based antennas 50. It will however be appreciated that the link could be via a satellite or in any other manner.

It will be appreciated that there could be more than one remote data processing system and that the invention is not limited to communication with a single data processing system. It will also be appreciated that the term ‘data processing system’ as meant herein is any apparatus, software or facility by which information is processed and is not limited to a specific type of construction or operating system.

The plug-in device 20 comprises a plug portion 21 for co-operation with the 12 volt power socket 13 and a body portion 22 that houses a number of modules 20A, 20C, 20L, 20M and 20P (indicated schematically in FIG. 1B) of the plug-in device 20.

In its most basic form the plug-in device 20 includes only a location module 20L, a communication module 20C and the plug 21. However, it is preferred if the plug-in device 20 further comprises a memory module 20M and a power module 20P that includes a rechargeable battery or other electrical power storage device.

The plug-in device 20 in some other embodiments further includes an acceleration module 20A.

The power module 20P transfers electrical power from the plug 21 to the other modules 20L, 20C, 20M, 20A present in the plug-in device 20 and also supplies electrical power to recharge the battery of the plug-in device 20. The battery sometimes referred to as a ‘keep alive power source’ is used to supply electrical power to the other modules 20L, 20C, 20M, 20A of the plug-in device 20 when the electrical power supply from the 12 volt power socket 13 is off.

It will be appreciated that on some motor vehicles the 12 volt power socket 13 is only live when the motor vehicle 5 is in a so called ‘Key-On’ state whereas in other arrangements the supply of electrical power to the 12 volt power socket 13 is permanently live.

The location module 20L can be of any known type such as, for example and without limitation, a GPS module, but in all cases is operable to provide a geographic location of the location module 20L and hence of the motor vehicle 5 when the plug-in device 20 is plugged into the 12 volt power socket 13 of the motor vehicle 5.

The memory module 20M includes one or more memory devices and stores a unique identity for the plug-in device 20. Upon purchasing or leasing the plug-in module 20 an owner/user is able to register the plug-in device 20 so that it can be used for recognition purposes such as electronic toll charging.

The acceleration module 20A provides data related to the dynamic behavior of the motor vehicle 5 and may provide the instantaneous acceleration of the motor vehicle 5 in up to three dimensions. Such a device is useful for assessing driver behavior or in the case of an accident for simulating or recreating an event.

The communication module 20C is a long range communication module to provide a communication link between the plug-in device 20 and the at least one remote data processing system 60. The communication module 20C can be of any known type such as, for example and without limitation, a GSM module, a Wi-Fi module or a WiMax module.

The function of the communication module 20C is to transfer information or data to the remote data processing system 60 for use in intelligent vehicle monitoring. Data from the memory module 20M, location module 20L and, if present, the accelerometer module 20A can be transferred via the communication module 20C to the remote data processing system 60. The communication module 20C may provide more than one communication pathway to more than one data processing system.

In use the plug-in module 20 provides information regarding at least the current location of the motor vehicle 5 and also, if so enabled, the identity of the plug-in device 20 and the dynamic behavior of the motor vehicle 5 to the remote data processing system 60. The remote data system 60 can then use the received data to facilitate intelligent vehicle monitoring of the motor vehicle 5.

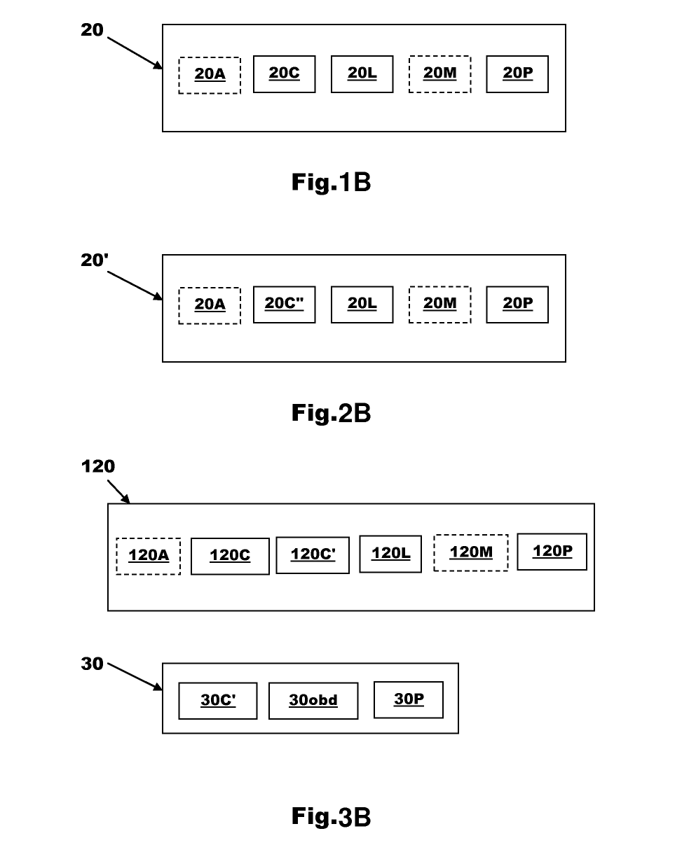

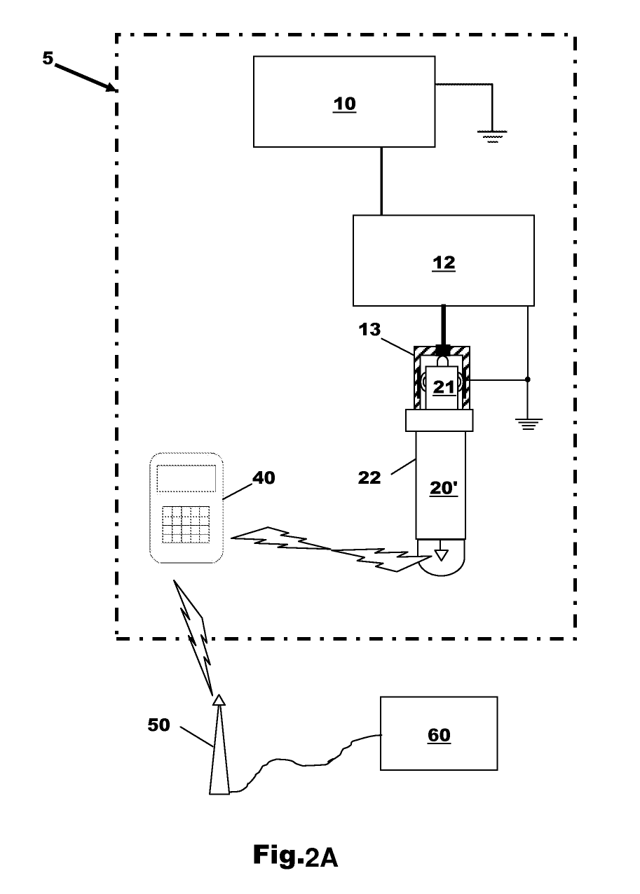

With reference to FIGS. 2A and 2B there is shown a motor vehicle 5 that is the same as that previously described with the exception that a second embodiment of an apparatus for transferring information from the motor vehicle 5 to the remote data processing system 60 is provided in the form of a single plug-in device 20′.

The single plug-in device 20′ is in most respects identical in construction and functionality to the plug-in device 20 described with respect to FIGS. 1A and 1B and will not be described again in detail.

The only significant difference between this second embodiment and the first embodiment is that the long range communication module 20C of the first embodiment is replaced by a short range communication module 20C″.

The short range or near field communication module 20C″ provides a communication link between the plug-in device 20′ and a mobile communication device 40 such as, for example, a mobile telephone. It will be appreciated that the communication device 40 could be any other device capable of serving as an intermediate communication node which relays or re-transmits information/data from the plug-in module 20′ to the remote processing system 60.

Therefore in this case the communication link between the plug-in device 20′ and the remote data processing system 60 is not a direct link but is provided via the mobile communication device 40 using the communication functionality of the mobile communication device 40.

In use the plug-in module 20′, as before, provides information regarding at least the current location of the motor vehicle 5 and also, if so enabled, the identity of the plug-in device 20′ and the dynamic behavior of the motor vehicle 5 to the remote data processing system 60. The remote data system 60 then uses the received data to facilitate intelligent vehicle monitoring of the motor vehicle 5.

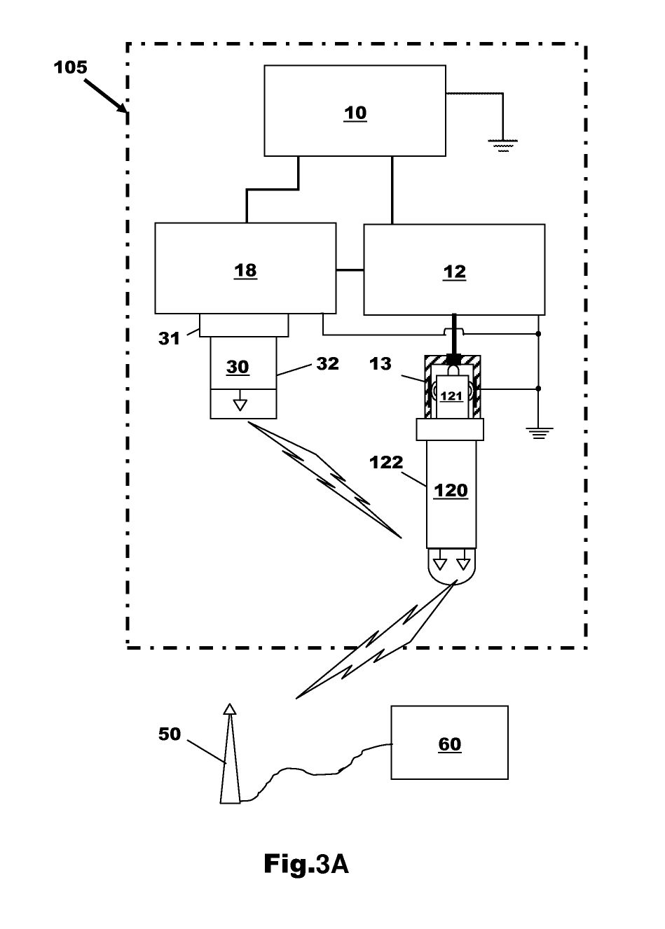

With particular reference to FIGS. 3A and 3B there is shown a motor vehicle 105 having a number of electrical systems 10 supplied with power from a main electric power system 12 of the motor vehicle 105. The motor vehicle 105 also includes an on-board diagnostic port (OBDP) 18 for supplying information regarding the operation of various components of the electrical systems 10, such as for example sensor performance and/or data produced by the various electrical systems 10. Such on-board diagnostic ports are well known in the art and are constructed in accordance with agreed standards.

An OBD system gives the vehicle owner or repair technician access via the OBD port to the status of the various vehicle sub-systems. The diagnostic information available via an OBD port which is a standardized digital communications port includes real-time data in addition to a standardized series of diagnostic trouble codes which allow a user to rapidly identify and remedy malfunctions within the vehicle.

Modern OBD ports often referred to as OBD-2 connectors generally have 16 connections (pins) and use the number 4 connection for earth and the number 16 connection for power thereby enabling a supply of power to be extracted from the OBDP 18 which acts as a standardized power outlet. It will be appreciated that more channels than those currently regulated for by OBD-2 standard could be monitored and transmitted as well as open XC.

Various protocols are used by vehicle manufacturers, the most common of which are:—

SAE J1850 PWM which is used by Ford Motor Company;

SAE J1850 VPW which is used by General Motors;

ISO 14230 KWP2000 which has been used by many European and Asian Manufacturers; and

ISO 15765 CAN which is used in the latest vehicles produced in Europe.

In all cases the number 16 connection is connected to the battery or main electrical circuit of the motor vehicle to which the OBDP is fitted and the number 4 connection is connected to earth.

The nature of the data supplied to the other connections of the OBDP has to be provided by the manufacture in a non-encrypted form and is defined by the respective protocol used.

It will be appreciated that the motor vehicle 105 also includes various other systems and components such as, for example and without limitation, a propulsion system, a transmission system, a number of road wheels, a suspension system, a body structure and accommodation for one or more occupants. None of these additional systems and components is shown on FIG. 3A as they are not directly relevant to the current invention.

The electric power system 12 includes a distribution system, a source of electric power such as a generator and at least one battery or electrical power storage device for use when the generator is not operating. The electric power system 12 also includes a number of power outlets such as a 12 volt power socket 13 which may be in the form of a cigar or cigarette lighter socket. As is well known in the art such electrical sockets are universally applied to motor vehicles and are of a standard design and configuration.

A third embodiment of an apparatus for transferring information from the motor vehicle 105 to a remote data processing system 60 is provided in the form of first and second plug-in devices 120, 30 respectively.

In the case of this embodiment the first plug-in device 120 communicates directly with the remote data processing system 60 via a wireless terrestrial link including one or more ground based antennas 50. It will however be appreciated that the link could be via a satellite or in any other manner.

It will be appreciated that there could be more than one remote data processing system and that the invention is not limited to communication with a single data processing system. It will also be appreciated that the term ‘data processing system’ as meant herein is any apparatus, software or facility by which information is processed and is not limited to a specific type of construction or operating system.

The first plug-in device 120 comprises a plug portion 121 for co-operation with the 12 volt power socket 13 and a body portion 122 housing a number of modules 120A, 120C, 120C′, 120L, 120M and 120P (indicated schematically in FIG. 3B) of the plug-in device 120.

In its most basic form the plug-in device 120 includes only a location module 120L, a pair of communication modules 120C, 120C′ and the plug 121. However, preferably the plug-in device 120 further comprises a memory module 120M and a power module 120P that includes a rechargeable battery or other electrical power storage device. The plug-in device 120 may also further include an acceleration module 120A.

The power module 120P transfers electrical power from the plug 121 to other modules 120L, 120C, 120C′, 120M, 120A present in the plug-in device 120 and also supplies electrical power to recharge the battery of the plug-in device 120. The battery sometimes referred to as a ‘keep alive power source’ is used to supply electrical power to the other modules 120L, 120C, 120C′, 120M, 120A of the plug-in device 120 when the electrical power supply from the 12 volt power socket 13 is off.

The location module 120L can be of any known type such as, for example and without limitation, a GPS module but in all cases is operable to provide a geographic location of the location module 120L and hence of the motor vehicle 5 when the plug-in device 120 is located in the motor vehicle 105.

The memory module 120M includes one or more memory devices and stores a unique identity for the plug-in device 120 is stored. As before, upon purchasing or leasing the plug-in module 120, an owner/user is able to register the plug-in device 20 using the unique identity which may be in the form of a serial number or serial code both constituting identity marks so that it can be used for vehicle/owner recognition purposes.

The acceleration module 120A provides data related to the dynamic behavior of the motor vehicle 105 and may provide the instantaneous acceleration of the motor vehicle 105 in three dimensions. Such a device is useful for assessing driver behavior or in the case of an accident for simulating or recreating an event.

A first communication module 120C is a long range communication module to provide a communication link between the plug-in device 120 and the at least one remote data processing system 60. The communication module 120C can be of any known type such as, for example and without limitation, a Wi-Fi or WiMax module. The function of the first communication module 120C is to transfer information or data to the remote data processing system 60 for use in intelligent vehicle monitoring. Data from the memory module 120M, location module 120L, the second plug-in device 30 and, if present, the accelerometer module 120A is transferred via the first communication module 120C which may provide more than one communication pathway.

The second communication module 120C′ is a short range or near field communication module such as, for example, a Bluetooth enabled device and provides a communication link between the first and second plug-in devices 120 and 30 or to be more specific between the second communications module 120C′ of the first plug-in module 120 and a communication module 30C′ of the second plug-in module 30.

The second plug-in module 30 further comprises a plug 31 for co-operation with the OBDP 18 and a body 32 housing a power module 30P, an on-board diagnostics data module 30obd and the communication module 30C′ (indicated schematically in FIG. 3B).

The plug 31 includes both data and power transfer connections and is used to supply power to all of the modules 30P, 30obd and 30C′ of the second plug-in device 30.

The power module 30P includes a battery or other rechargeable electric power storage device and is charged from the power supplied via the plug 31. The power module supplies power to other modules 30A, 30M, 30obd and 30C′ of the second plug-in device 30

The on-board diagnostics data module 30obd receives data from the OBDP 18 via the plug 31 and performs any necessary processing required for transmission of the collected data via the communications module 30C′.

The communications module 30C′ is operable to transmit data or information received from the on-board diagnostics data module 30obd to the second communications module 120C′ of the first plug-in device 120.

In use the plug-in module 120 provides information regarding at least the current location of the motor vehicle 105 and also, if so enabled, the identity of the plug-in device 20 and the dynamic behavior of the motor vehicle 105 to the remote data processing system 60 along with any on-board diagnostic data or information received from the second plug-in device 30. The remote data system 60 can then use the received data to facilitate intelligent monitoring of the motor vehicle 105.

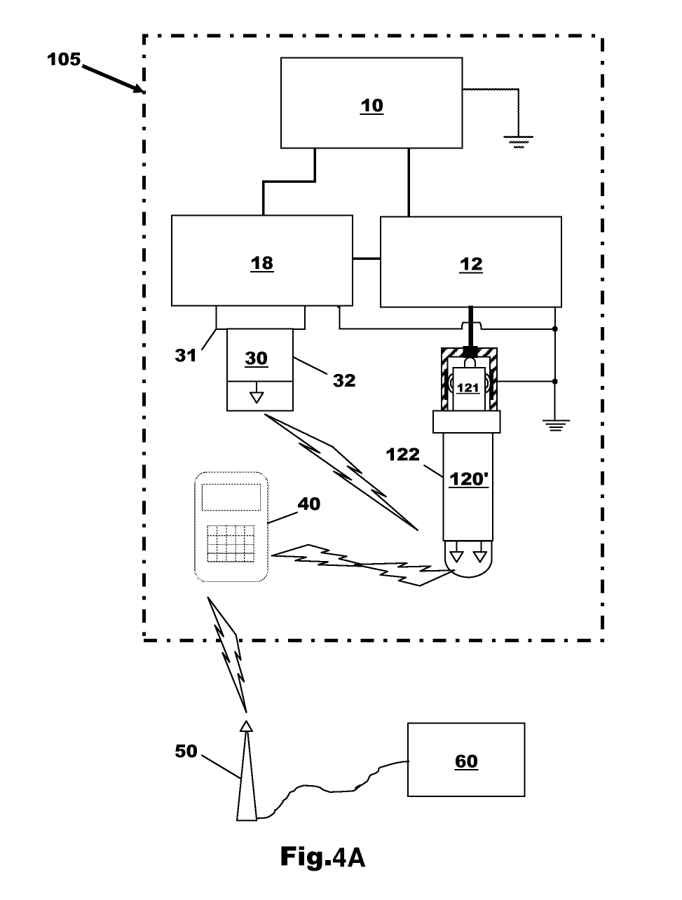

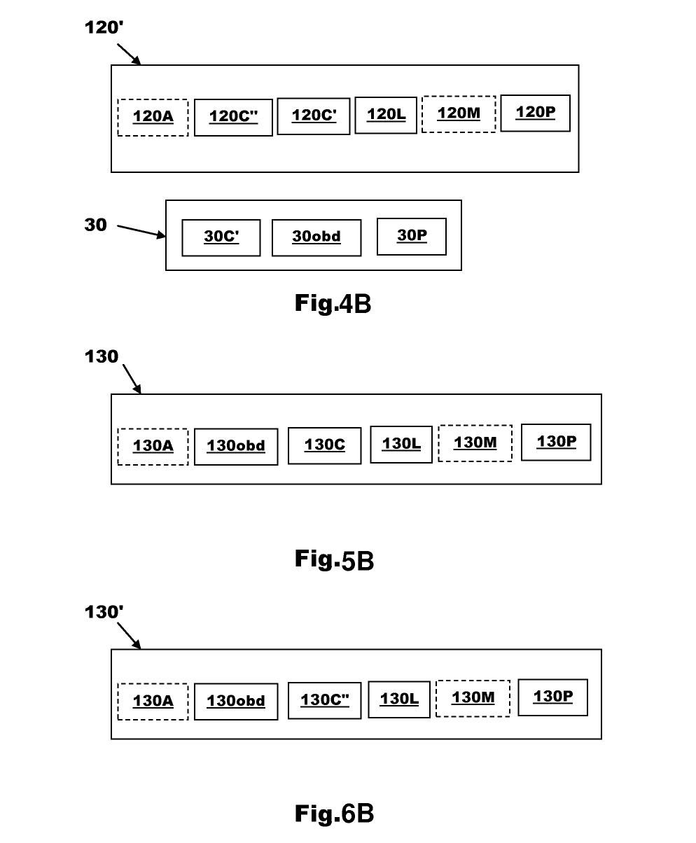

With reference to FIGS. 4A and 4B there is shown a motor vehicle 105 that is the same as that previously described with reference to FIGS. 3A and 3B with the exception that a fourth embodiment of an apparatus for transferring information from the motor vehicle 105 to the remote data processing system 60 is provided.

The only significant difference between this fourth embodiment and the third embodiment is that the long range communication module 120C in the first plug-in device 120 of the third embodiment is replaced by a short range communication module 120C″ (indicated schematically in FIG. 4B) in the first plug-in device 120′ in this fourth embodiment.

The short range or near field communication module 120C″ provides a communication link between the first plug-in device 120′ and a mobile communication device 40 such as, for example, a mobile telephone. It will be appreciated that the communication device 40 could be any other device capable of serving as an intermediate communication node which relays or re-transmits information/data from the plug-in module 120′ to the remote processing system 60.

Therefore in this case the communication link between the plug-in device 120′ and the remote data processing system 60 is not a direct link but is provided via the mobile communication device 40 using the communication functionality of the mobile communication device 40.

In use the first plug-in module 120′ provides information regarding at least the current location of the motor vehicle 105 and also, if so enabled, the identity of the plug-in device 120′, the dynamic behavior of the motor vehicle 105 along with any on-board diagnostic data or information it has received from the second plug-in device 30 to the remote data processing system 60. The remote data system 60 can then use the received data to facilitate intelligent monitoring of the motor vehicle 105.

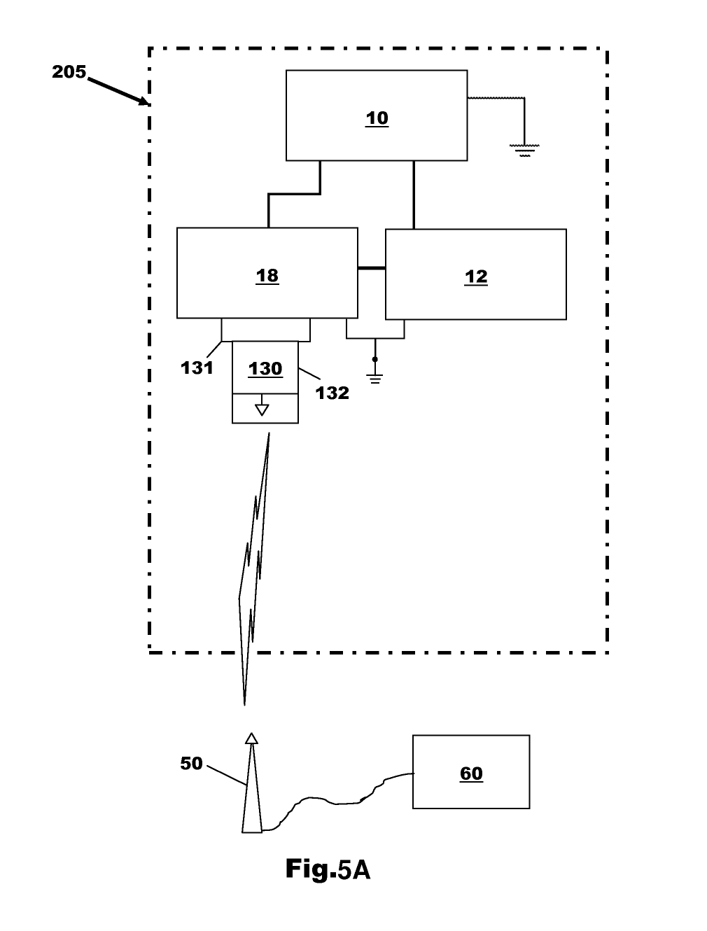

With particular reference to FIGS. 5A and 5B there is shown a motor vehicle 205 having, as before, a number of electrical systems 10 supplied with power from a main electric power system 12 of the motor vehicle 205. It will be appreciated that the motor vehicle 205 also includes various other systems and components such as, for example and without limitation, a propulsion system, a transmission system, a number of road wheels, a suspension system, a body structure and accommodation for one or more occupants. None of these additional systems and components is shown on FIG. 1A as they are not directly relevant to the current invention.

The electric power system 12 includes a distribution system, a source of electric power such as a generator and at least one battery or electrical power storage device for use when the generator is not operating. The electric power system 12 also includes a number of power outlets one of which is formed as part of an on-board diagnostics port (OBDP) 18. As is well known in the art most modern motor vehicle are fitted with an OBDP 18 and these are of a standard design and configuration as previously referred to.

A fourth embodiment of an apparatus for transferring information from the motor vehicle 205 to a remote data processing system 60 is provided in the form of a single plug-in device 130.

The plug-in device 130 includes a plug 131 for co-operation with the OBDP 18 and a body 132 that houses a number of modules 130A, 130obd, 130C, 130L, 130M and 130P (indicated schematically in FIG. 5B).

In the case of this embodiment the plug-in device 130 communicates directly with the remote data processing system 60 via a wireless terrestrial link including one or more ground based antennas 50. It will however be appreciated that the link could be via a satellite or in any other manner. It will also be appreciated that there could be more than one remote data processing system and that the invention is not limited to communication with a single data processing system.

In its most basic form the plug-in device 130 includes only a location module 130L, a communication module 130C, an on-board diagnostic module 130obd and the plug 131. However, it is preferred if the plug-in device 130 further comprises a memory module 130M and a power module 130P.

The plug-in device 130 in some other embodiments may further include an acceleration module 130A providing data relating to instantaneous acceleration of the motor vehicle 205 in up to three dimensions.

The power module 130P includes a rechargeable battery or other electrical power storage device that is charged by electrical power received from the OBDP 18 via the plug 131 and also acts to transfer electrical power from the plug 131 to any of the other modules 130L, 130C, 130M, 130obd, 130A present in the plug-in device 130. The battery sometimes referred to as a ‘keep alive power source’ is used to supply electrical power to the other modules 130L, 130C, 130M, 130obd, 130A of the plug-in device 130 when the electrical power supply from the OBDP 18 is off. It will be appreciated that on some motor vehicles the OBDP 18 is only live when the motor vehicle is in a so called ‘Key-On’ state with the engine running whereas in other types of motor vehicle the supply of electrical power to the OBDP 18 is live whenever a ‘Key-On’ state exists.

The location module 130L can be of any known type such as, for example and without limitation, a GPS module but in all cases is operable to provide a geographic location of the location module 130L and hence of the motor vehicle 205 when the plug-in device 130 is located in the motor vehicle 205.

The memory module 130M includes one or more memory devices and stores a unique identity for the plug-in device 130 such as an identity mark. Upon purchasing or leasing the plug-in module 130 an owner/user is able to register the plug-in device 130 so that it can be used for recognition purposes such as electronic toll charging.

The acceleration module 130A provides data related to the dynamic behavior of the motor vehicle 205 by sensing acceleration of the motor vehicle 205 in up to three dimensions. Such a device is useful for assessing driver behavior or in the case of an accident for simulating or recreating an event.

The communication module 130C is a long range communication module to provide a communication link between the plug-in device 130 and the at least one remote data processing system 60. The communication module 130C can be of any known type such as, for example and without limitation, a Wi-Fi or WiMax module. The function of the communication module 130C is to transfer information or data to the remote data processing system 60 for use in intelligent vehicle monitoring. Data from the memory module 130M, location module 130L, on-board diagnostics module 130obd and, if present, the accelerometer module 130A is transferred via the communication module 130C which may provide more than one communication pathway.

In use the plug-in module 130 continuously provides information regarding at least the current location of the motor vehicle 205 and diagnostic information relating to the operational status of the motor vehicle 205 and also, if so enabled, the identity of the plug-in device 130 and the dynamic behavior of the motor vehicle 205 to the remote data processing system 60. The remote data system 60 can then use the received data to facilitate intelligent monitoring of the motor vehicle 205.

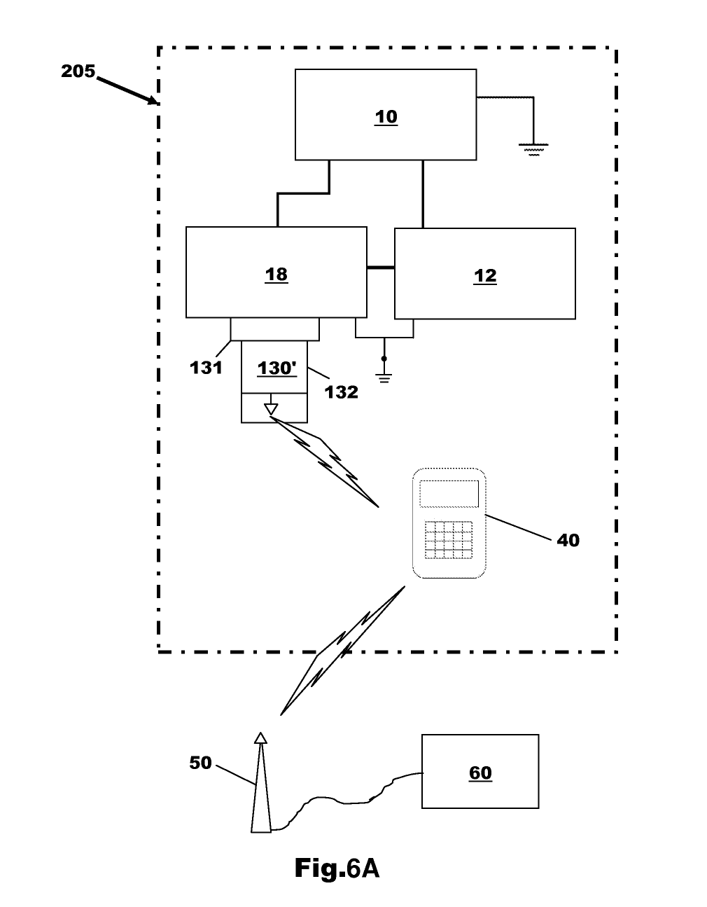

With reference to FIGS. 6A and 6B there is shown a motor vehicle 205 that is the same as that previously described with the exception that a sixth embodiment of an apparatus for transferring information from the motor vehicle 205 to the remote data processing system 60 is provided in the form of a single plug-in device 130′.

The single plug-in device 130′ is in most respects identical in construction and functionality to the plug-in device 130 described with respect to FIGS. 5A and 5B and will not be described again in detail.

The only significant difference between this sixth embodiment and the fifth embodiment is that the long range communication module 130C of the fifth embodiment is replaced by a short range communication module 130C″ (indicated schematically in FIG. 6B) in this sixth embodiment.

The short range or near field communication module 130C″ such as, for example and without limitation, a Bluetooth module provides a communication link between the plug-in device 130′ and a mobile communication device 40 such as, for example, a mobile telephone. It will be appreciated that the communication device 40 could be any other device capable of serving as an intermediate communication node which relays or re-transmits information/data from the plug-in module 130′ to the remote processing system 60.

Therefore in this case the communication link between the plug-in device 130′ and the remote data processing system 60 is not a direct link but is provided via the mobile communication device 40 using the communication functionality of the mobile communication device 40.

In use the plug-in module 130′ provides information regarding at least the current location of the motor vehicle 205 and diagnostic data relating to the operational status of the motor vehicle 205. The plug-in module 130′ may also provide, if so enabled, the identity of the plug-in device 130′ and the dynamic behavior of the motor vehicle 205 to the remote data processing system 60. The remote data system 60 can then use the received data to facilitate intelligent monitoring of the motor vehicle 205.

Therefore in summary the invention provides and apparatus comprising of one or two plug-in devices that can be fitted to existing motor vehicles to produce the type of information required by existing and proposed intelligent vehicle monitoring systems.

By including an integral plug that can be plugged directly into a standard vehicle power outlet to obtain a source of electrical power from the motor vehicle no significant installation costs are incurred and the apparatus can be fitted by any user of a motor vehicle without the need for specialist knowledge or training.

It will be appreciated by those skilled in the art that although the invention has been described by way of example with reference to one or more embodiments it is not limited to the disclosed embodiments and that alternative embodiments could be constructed without departing from the scope of the invention as defined by the appended claims.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. Apparatus for transferring data from a motor vehicle to a remote data processing system, comprising:
a first plug-in device for insertion into an on-board diagnostic port of the vehicle and comprising:
an electrical connector connectable with the on-board diagnostic port to receive electrical power therefrom;
an on-board diagnostic module to collect diagnostic data regarding operation of the vehicle via the on-board diagnostic port; and
a communication module for transmitting the diagnostic data via a short-range communications link;
and
a second plug-in device for insertion into a power socket of the vehicle and comprising:
an electrical connector connectable with the power socket to receive electrical power therefrom;
a location module for determining a geographic location of the vehicle;
a first communication module for receiving the diagnostic data transmitted via the short-range communication link; and
a second communication module for transmitting the geographic location of the vehicle to the remote data processing system, and re-transmitting to the remote data processing system the diagnostic data received by the first communication module.

2. The apparatus of claim 1 wherein the second communication module is adapted for short-range communication with an intermediate communication node on-board the vehicle, the intermediate communication node re-transmitting the geographic location and the diagnostics data to the remote data processing system.

3. The apparatus of claim 2 wherein the second communication module is adapted for short-range communication with a mobile communication device serving as the intermediate communication node.

4. The apparatus of claim 1 wherein at least one of the first and the second plug-in devices further comprises a memory module for storing an identity mark for the at least one plug-in device.

5. The apparatus of claim 1 wherein at least one of the first and the second plug-in devices further comprises an electrical energy storage device for providing electrical power to the at least one plug-in device if electrical power from the vehicle is unavailable.

6. The apparatus of claim 1 wherein at least one of the first and the second plug-in devices further comprises an accelerometer module for providing information regarding dynamic behavior of the motor vehicle.

7. Apparatus comprising:
a first plug-in device insertable into an on-board diagnostic port of a vehicle and transmitting via a short-range communications link diagnostic data collected from the on-board diagnostic port; and
a second plug-in device insertable into a power socket of the vehicle, receiving the diagnostic data transmitted by the first plug-in device, and re-transmitting the diagnostic data along with a geographic location of the vehicle to a remote data processing system.

8. The apparatus of claim 7 wherein the second plug-in device is adapted for short-range communication with an intermediate communication node on-board the vehicle which re-transmits the geographic location and the diagnostics data to the remote data processing system.

9. The apparatus of claim 8 wherein the second plug-in device is adapted for short-range communication with a mobile communication device serving as the intermediate communication node.

10. The apparatus of claim 7 wherein at least one of the first and the second plug-in devices comprises a memory module for storing an identity mark for the at least one plug-in device.

11. The apparatus of claim 7 wherein at least one of the first and the second plug-in devices comprises an electrical energy storage device for providing electrical power to the at least one plug-in device if electrical power from the vehicle is unavailable.

12. The apparatus of claim 7 wherein at least one of the first and the second plug-in devices comprises an accelerometer module for providing information regarding dynamic behavior of the vehicle.

13. A motor vehicle having apparatus for transferring information from the vehicle to a remote data processing system, the apparatus comprising:
a power socket connected with an electric power circuit of the vehicle;
an on-board diagnostic port connected with an on-board diagnostic system of the vehicle;
a first plug-in device insertable into the on-board diagnostic port to collect diagnostic data therefrom and transmit the diagnostic data via a short-range communications link; and
a second plug-in device insertable into the power socket to receive the diagnostic data transmitted by the first plug-in device and re-transmit the diagnostic data along with a geographic location of the vehicle to a remote data processing system.

14. The motor vehicle of claim 13 wherein the second plug-in device is adapted for short-range communication with an intermediate communication node on-board the vehicle which re-transmits the geographic location and the diagnostics data to the remote data processing system.

15. The motor vehicle of claim 14 wherein the second plug-in device is adapted for short-range communication with a mobile communication device serving as the intermediate communication node.

16. The motor vehicle of claim 13 wherein at least one of the first and the second plug-in devices comprises a memory module for storing an identity mark for the at least one plug-in device.

17. The motor vehicle of claim 13 wherein at least one of the first and the second plug-in devices comprises an electrical energy storage device for providing electrical power to the at least one plug-in device if electrical power from the vehicle is unavailable.

18. The motor vehicle of claim 13 wherein at least one of the first and the second plug-in devices comprises an accelerometer module for providing information regarding dynamic behavior of the motor vehicle.
